(19) United States
(12) Patent Application Publication
(10) Pub. No.: US 2016/0085774 A1
(43) Pub. Date: Mar. 24, 2016

(54) CONTEXT BASED IMAGE SEARCH

(71) Applicants: Sandliya BHAMIDIPATI, Mountain View, CA (US); Nadia FAWAZ, Santa Clara, CA (US); Jonathan Brooks WHITEAKER, Menlo Park, CA (US); THOMSON LICENSING, Issy les Moulineaux (FR)

(72) Inventors: Sandliya Bhamidipati, Mountain View, CA (US); Nadia Fawaz, Santa Clara, CA (US); Jonathan Brooks Whiteaker, Menlo Park, CA (US)

(21) Appl. No.: 14/787,777

(22) PCT Filed: Jun. 12, 2013
(86) PCT No.: PCT/US2013/045297

§ 371 Date: Oct. 29, 2015

(51) Int. Cl. G06F 17/30

(52) U.S. Cl. CPC G06F 17/30268; G06F 17/3028; G06F 17/30377; G06F 17/30867

(57) ABSTRACT

A method comprising receiving an image, the image including associated contextual information; converting the received image into searchable image data, the searchable image data being descriptive of the received image; filtering information from a search database based on the contextual information associated with the received image to create a filtered information set; collecting a plurality of images from the filtered information set to create a seed data set; comparing the received image to the plurality of images from the seed data set using the searchable image data; and determining whether one of the plurality of images is related to the received image.

### BACKGROUND

In order to perform a search of an image, common commercially available search engines take a keyword that is descriptive of the image to be searched and attempt to find related images. However, sometimes a user has nothing more than an image or picture of his/her search target. For instance, when a user is searching for the identity of a particular person and only has a picture of that person, the user must type in descriptive keywords about the image in order to learn more. But when the user knows little about the subject of the image, it becomes difficult for the user to conceive of such keywords to assist his or her search. To solve this problem, image-based search engines have been created to allow the image itself to be the keyword used for searching. In such systems, the search engine receives an image and deconstructs or converts the image into data about the image that function as searchable terms. Such systems then use these converted image-based search terms to produce additional pictures or images found on the Internet that bear a resemblance with the originally searched image.

Unfortunately, current image-based search engines search only the image data and do not limit their search based on any contextual data associated with the image. As a result, such search engines crawl a huge amount of images from around the Internet to produce a large number of results that then must be compared to the original image. The only contextual information used by the search engine is the information regarding the web pages from which the images were found. This results in the search engine taking a long time searching its large data set to produce information that may or may not be relevant to the user.

### SUMMARY

In view of the foregoing, a contextual image based search method is disclosed. The method comprising receiving an image from a user, the image including contextual information associated with the image; converting the image into searchable image data, the searchable image data being descriptive of the received image; filtering information from a search database based on the contextual information associated with the received image to create a filtered information set; collecting a plurality of images from the filtered information set to create a seed data set; comparing the received image to the plurality of images from the seed data set using the searchable image data; and determining whether one of the plurality of images is related to the received image.

In addition, a contextual image based search system is disclosed. The system comprising a search database and a server, wherein the server includes a memory and a processor. The search database includes searchable information stored thereon, which includes a plurality of images. The server's memory is configured to store a received image and contextual information associated with the image. The server's processor is configured to receive an image, the received image including contextual information associated the image; convert the image into searchable image data, the searchable image data being descriptive of the image; store the searchable image data and the contextual information in the memory; filter the searchable information from the search database based on the contextual information associated with the image to create a filtered information set; collect a plurality of images from the filtered information set to create a seed data set; compare the received image to the plurality of images from the seed data set using the searchable image data; and determine whether one of the plurality of images is related to the received image.

### BRIEF DESCRIPTION OF THE DRAWING

For a more complete understanding of the present invention, reference is made to the following detailed description of an embodiment considered in conjunction with the accompanying drawing, in which:

FIG. 1 is a flow chart showing an image based search method in accordance with an embodiment of the present invention.

### DETAILED DESCRIPTION

Image-based search techniques where the image itself is used as a basis for the search are described below. The techniques involve processing an image into data that can be used as a key search term, or “key-image,” and coupling such image data with contextual information about the image, such as when and where the image was created and with whom the image is associated. This method allows one to use the key-image plus contextual information to find related images and information. In one embodiment, a method involves using a picture of a person as a search term to learn more about the person depicted in the picture.

It should be understood that the elements shown in the figures can be implemented in various forms of hardware, software or combinations thereof. Preferably, these elements are implemented in a combination of hardware and software on one or more appropriately programmed general-purpose devices, which may include a processor, memory and input/output interfaces.

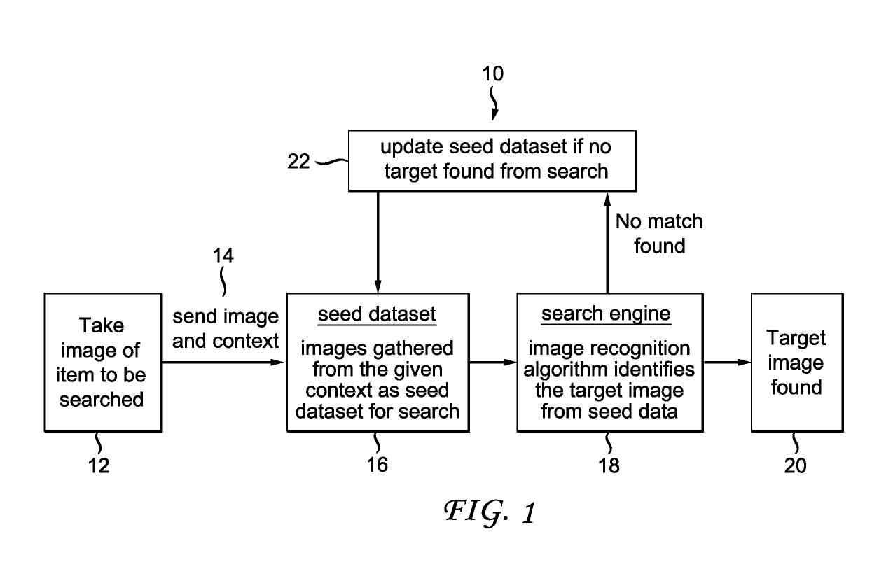

Turning to FIG. 1, a flow chart illustrating a view of an image and context based search method 10 according to one embodiment is shown. In this embodiment, a user sends an image with contextual metadata to a server hosting a search application that assists in performing the method illustrated in FIG. 1. In one embodiment, the method finds information about a person based on a search of the person's picture. Other embodiments include searching for information using an image of, for example, a piece of art, a landmark, an event or gathering, or a plant or animal species and the like.

Still referring to FIG. 1, the method 10 begins by receiving an image of a person and collecting contextual metadata associated with the image (step 12), such as, for example, location data (e.g., global positioning system (“GPS”) coordinates) and/or timing data and the like. In one embodiment, an image is received from a smart phone having an embedded camera that can capture and attach rich metadata to the image. In another embodiment, the image is received with a traditional digital camera whereupon uploading the image from the digital camera to a server, the Internet Protocol (IP) address associated with an uploading site can be attached to an image to attain location data therefrom.

Once an image and associated contextual metadata have been collected, the image and metadata are uploaded to a server (step 14). The server converts the image into searchable data and stores such data along with the contextual metadata in a storage database. In one embodiment, a server converts an image into a set of vectors, each vector having a set of values computed to describe the visual properties of a portion of the image. In another embodiment, a server uses a face detection algorithm to identify and extract faces it finds in an image and stores such faces in a storage database as image data.

The server then uses the contextual metadata from a received image to filter information from a search database (step 16). In one embodiment, this search database contains information crawled from the Internet that relates to certain events, such as conferences, meetings, and trade shows in a predefined area. In another embodiment, the search database contains preloaded information from a social network. In one embodiment, the server filters the information from the search database based on the location metadata associated with the received image, thereby limiting the filtered information to that which is associated with the location from which the received image was taken. In another embodiment, the server also filters the information from the search database based on the timing metadata associated with the received image, thereby limiting the filtered information to that which is associated with an event that took place on the day the received image was taken.

Once the server has filtered the separate database's information using the contextual metadata from the received image, the filtered information is then crawled to obtain images of persons to create a seed data set for an image search. In addition, any other external links found in the filtered information, such as, for example, professional websites and social networking web pages associated with the persons identified in the seed data set, are indexed and stored for future use.

The server then performs an image comparison between the received image and the images found in the seed data set (step 18). In one embodiment, the server converts the images found in the seed data set into sets of image vectors and compares them to the set of image vectors created from the received image. In another embodiment, the server uses the face detection algorithm to compare the faces it finds in the seed data set to the faces stored on the server's storage database. When a relationship to the received image is found from the seed data set, the server returns the found image from the seed data set along with any additional information associated with the found image, such as the name of the person depicted therein (step 20).

If no relationship is found, or a user indicates that a found image is not correct, the server updates the seed data set based on additional information found from the indexed external links (step 22). Such information includes, for example, names of persons found on social networks, including the names of persons connected to the persons identified in the seed data set. Such information can also include the names of organizations associated with the events found in the search database, along with the persons associated with such organizations. This additional information is then crawled for images as discussed above in step 16, and such images are then added to the updated seed data set. An image comparison is then conducted on the updated seed data set to determine if a relationship to the received image is found (step 18). This process continues until such a relationship is found or until a set of images close enough (e.g., according to some threshold) to the received image is found. In one example, a small set of results can be returned to the user, in decreasing order of relevance (e.g., based on similarity with the received image), instead of a single image, if the relationship is not perfect.

The method disclosed above allows for a streamlined image search by filtering based on contextual data associated with the image to be searched. In addition, by continually updating the seed data set, the method allows for the continual building of a search database for future use by future users.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

1. A method of image based searching comprising:
(a) receiving an image, the image including associated contextual information;
(b) converting the received image into searchable image data, the searchable image data descriptive of the image;
(c) filtering information from a search database based on the associated contextual information to create a filtered information set;
(d) collecting a plurality of images from the filtered information set to create a seed data set;
(e) comparing the received image to the plurality of images from the seed data set using the searchable image data; and
(f) determining whether one of the plurality of images is related to the received image.

2. The method according to claim 1, wherein the collecting includes indexing external links associated with the plurality of images of the seed data set, the external links being associated with web pages having associations with at least one of the plurality of images.

3. The method according to claim 2, further comprising:
(g) updating the seed data set with additional images when no relation between any one of the plurality of images and the received image has been determined.

4. The method according to claim 3, wherein (d)-(g) are repeated in order until one of the plurality of images from the seed data set is determined to be related to the received image.

5. The method according to claim 1, wherein the contextual information includes an internet protocol address having location information that describes a source of the received image.

6. The method according to claim 1, wherein the contextual information includes metadata associated with the received image.

7. The method according to claim 6, wherein the metadata includes location-based information identifying a location from where the received image originated and timing-based information identifying a time from when the received image originated.

8. A contextual image based search system comprising:
a search database including searchable information stored thereon, the searchable information including a plurality of images;
a server including a memory and a processor, the memory being configured to store a received image and contextual information associated with the received image, and the processor configured to perform the following:
(a) receive an image, the image including associated contextual information;
(b) convert the received image into searchable image data, the searchable image data descriptive of the received image;
(c) store the searchable image data and the contextual information in the memory;
(d) filter the searchable information from the search database based on the contextual information associated with the received image to create a filtered information set;
(e) collect the plurality of images from the filtered information set to create a seed data set;
(f) compare the received image to the plurality of images from the seed data set using the searchable image data; and
(g) determine whether one of the plurality of images is related to the received image.

9. The system according to claim 8, wherein the processor is further configured to index external links associated with the plurality of images of the seed data set, the external links being associated with web pages having associations with one or more of the plurality of images.

10. The method according to claim 9, wherein the processor is further configured to:
(h) update the seed data set with additional images when no relation between any one of the plurality of images and the received image has been determined.

11. The method according to claim 10, wherein the processor is configured to repeat (d)-(h) in order until it determines that one of the plurality of images from the seed data set is related to the received image.
